(19) United States
(12) Patent Application Publication
(10) Pub. No.: US 2015/0091796 A1
(43) Pub. Date: Apr. 2, 2015

(54) DISPLAY APPARATUS AND CONTROL METHOD THEREOF

(71) Applicant: SAMSUNG ELECTRONICS CO., LTD., Suwon-si (KR)

(72) Inventors: Oh-yun KWON, Seoul (KR); Young-chan RYU, Suwon-si (KR); Byung-jo JUN, Seongnam-si (KR)

(73) Assignee: SAMSUNG ELECTRONICS CO., LTD., Suwon-si (KR)

(21) Appl. No.: 14/502,359

(22) Filed: Sep. 30, 2014

(30) Foreign Application Priority Data
Sep. 30, 2013 (KR) 10-2013-0116291
May 28, 2014 (KR) 10-2014-0064259

(51) Int. Cl. G06F 3/01; G06T 3/40

(52) U.S. Cl. CPC G06F 3/013; G06T 3/40
USPC 345/156

(57) ABSTRACT

A display apparatus includes: a display configured to be bendable; a signal processor configured to process an image signal to display an image on the display; a detector configured to detect a bending state of the display; a camera configured to detect a sightline of a user; and a controller configured to control the signal processor to adjust a displayed state of the image for at least one of a first area and a second area in an entire display area of the display in response to on the detected bending state of the display being detected by the detector, wherein the first area corresponds to the detected sightline of the user detected by the camera, and wherein the second area is a different area from the first area.

### CROSS-REFERENCE TO RELATED APPLICATION

This application claims priority from Korean Patent Application No. 10-2013-0116291, filed on Sep. 30, 2013 and Korean Patent Application No. 10-2014-0064259, filed on May 28, 2014 in the Korean Intellectual Property Office, the disclosures of which are incorporated herein by reference.

### BACKGROUND

1. Technical Field

Apparatuses consistent with the exemplary embodiments relate to a display apparatus capable of processing various kinds of image data to display images and a control method thereof. In particular, exemplary embodiments relate to a display apparatus which employs a display which is bendable at a predetermined curvature and provides an image with an improved displayed state on the bent display, and a control method thereof.

2. Description of the Related Art

A related art display apparatus processes an image signal input from an external image source to display an image on a display panel configured in various forms, for example, a liquid crystal display (LCD). A related art display apparatus which is currently available may be a TV or monitor. For instance, a related art display apparatus provided as a TV displays an image of a user-desired broadcast channel by conducting various processes, such as tuning and decoding, on a broadcast signal transmitted from a broadcasting station or processes image data received from a content provider connected locally or via a network to display content image.

A related art display panel used for a display apparatus has a rectangular flat surface with a curvature of substantially 0. An image is displayed on the rectangular flat surface. However, different display panel structures have been developed. For example, a transparent display structure which enables a user to identify an image at both front and back sides of a display panel or a flexible display structure employing a display panel bent at a predetermined curvature have been developed. In these examples, the image may be displayed on the bent display panel or on both sides of the display panel.

A flexible display panel may have a structure in which the display panel has a flat surface but forms a bent surface at a predetermined curvature when a user applies an external force to the panel and a structure in which the display panel always forms a bent surface at a preset curvature regardless of the user applying an external force. A display apparatus which adopts the former structure may be used for a tablet, an electronic book, an electronic newspaper, or the like, and a display apparatus employing the latter structure may be used for an advertising panel installed on a circular column. However, when an image is displayed on a bendable display panel, the user may perceive the image as being distorted. Thus, a perceived image on the bendable display panel may be different from a perceived image on a flat surface (shown as non-distorted). Thus, a structure or image processing method which enables a user to normally perceive an image displayed on a bent surface may be required.

### SUMMARY

An aspect of an exemplary embodiment may provide a display apparatus which includes: a display configured to be bendable; a signal processor configured to process an image signal to display an image on the display; a detector configured to detect a bending state of the display; a camera configured to detect a sightline of a user; and a controller configured to control the signal processor to adjust a displayed state of the image for at least one of a first area and a second area in an entire display area of the display in response to the detected bending state of the display being detected by the detector, wherein the first area corresponds to the detected sightline of the user detected by the camera, and wherein the second area is a different area from the first area.

The controller may be further configured to adjust a scale of the image displayed in the at least one of the first area and the second area such that the displayed state of the image is adjusted.

The controller may be further configured to downscale and display an entire image in the first area at a resolution of the first area, wherein the entire image corresponds to the entire display area.

The controller may be further configured to display no image in the second area when the downscaled image is displayed in the first area.

The controller may be further configured to upscale and display the image in the first area which corresponds to the first area of an entire image which corresponds to the entire display area.

The controller may be further configured to adjust a plurality of images to different scales which correspond to the first area and the second area, respectively.

The controller may be further configured to adjust a brightness of the image displayed in the at least one of the first area and the second area such that the displayed state of the image is adjusted.

The controller may be further configured to adjust the brightness of the first area to be a higher brightness than a brightness of the second area.

The controller may be further configured to restore the adjusted display state of the image to an original displayed state in response to the detector detecting that the display returns from a bent state to an original flat state.

The controller may be further configured to determine an area with a preset pixel area range based on a specified pixel area as the first area in response to a pixel area to which the sightline of the user is directed being specified in the entire display area by the detector.

The controller may be further configured to obtain a curvature of a specified pixel area and determine a pixel area within a preset area within a preset range of the curvature from the specified pixel area as the first area in response to a pixel area to which the sightline of the user is directed being specified in the entire display area by the detector.

An aspect of an exemplary embodiment may provide a control method of a display apparatus, the control method includes: detecting a bending state of a display of the display apparatus; detecting a sightline of the user; and adjusting a displayed state of an image for at least one of a first area and a second area in an entire display area of the display in response to the detected bending state of the display, wherein the first area corresponds to the detected sightline of the user, and wherein the second area a different area from the first area.

The adjusting the displayed state of the image may include adjusting a scale of the image displayed in the at least one of the first area and the second area.

The adjusting the scale of the image may include downscaling and displaying an entire image in the first area at a resolution of the first area, wherein the entire image corresponds to the entire display area.

The adjusting the scale of the image may further include displaying no image in the second area when the downscaled image is displayed in the first area.

The adjusting the scale of the image may include upscaling and displaying an image in the first area of an entire image, wherein the entire image corresponds to the entire display area.

The adjusting the scale of the image may include adjusting a plurality of images to different scales which corresponds to the first area and the second area, respectively.

The adjusting the displayed state of the image may include adjusting a brightness of the image displayed in the at least one of the first area and the second area.

The adjusting the brightness of the image may include adjusting the brightness of the first area to be a higher brightness than a brightness of the second area.

The control method may further include restoring the adjusted displayed state of the image to an original displayed state in response to detecting that the display returns from a bent state to an original flat state.

An aspect of an exemplary embodiment may provide a control method of a display apparatus, the control method includes: displaying an image on an entire image display area of a display of the display apparatus; detecting whether the display is bent; detecting a sightline of a user; obtaining a curvature with respect to the entire image display area of the display in response to detecting that the display is bent; dividing the entire image display area into a first area in which the sightline of the user is detected and a second area which is a remaining area of the entire image display area based on the obtained curvature with respect to the entire image display area of the display; and adjusting the image on the display to different scales depending on whether a portion of the image is in the first area or the second area.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 illustrates a display apparatus according to a first exemplary embodiment.

FIG. 2 illustrates the display apparatus of FIG. 1 which is bent convexly.

FIG. 3 illustrates the display apparatus of FIG. 1 which is bent concavely.

FIG. 4 illustrates a display apparatus according to a second exemplary embodiment.

FIG. 5 is a block diagram illustrating a configuration of the display apparatus of FIG. 1.

FIG. 6 is a block diagram illustrating a configuration of a signal processor of the display apparatus of FIG. 1.

FIGS. 7 to 9 illustrate an overall view of the display apparatus of FIG. 1 which is bent.

FIG. 10 illustrates that a camera detects a sightline of a user when the display apparatus of FIG. 1 is bent.

FIG. 11 illustrates a method of detecting a sightline of a user using an external camera according to a third exemplary embodiment.

FIG. 12 is a flowchart illustrating a control method of a display apparatus according to a fourth exemplary embodiment.

FIG. 13 is a flowchart illustrating a control method of a display apparatus according to a fifth exemplary embodiment.

FIGS. 14 and 15 are lateral views illustrating a display apparatus which is bent according to a sixth exemplary embodiment.

FIG. 16 is a flowchart illustrating a control method of the display apparatus according to the sixth embodiment.

FIG. 17 illustrates a display apparatus according to a seventh exemplary embodiment.

### DETAILED DESCRIPTION OF EXEMPLARY EMBODIMENTS

Hereinafter, exemplary embodiments will be described in detail with reference to the accompanying drawings. In the following description, constituent parts or elements directly related to the embodiments will be mentioned, and descriptions of other parts or elements will be omitted. However, it should be noted that the omitted parts or elements are not construed as being unnecessary in configuring a device or system according to the exemplary embodiments.

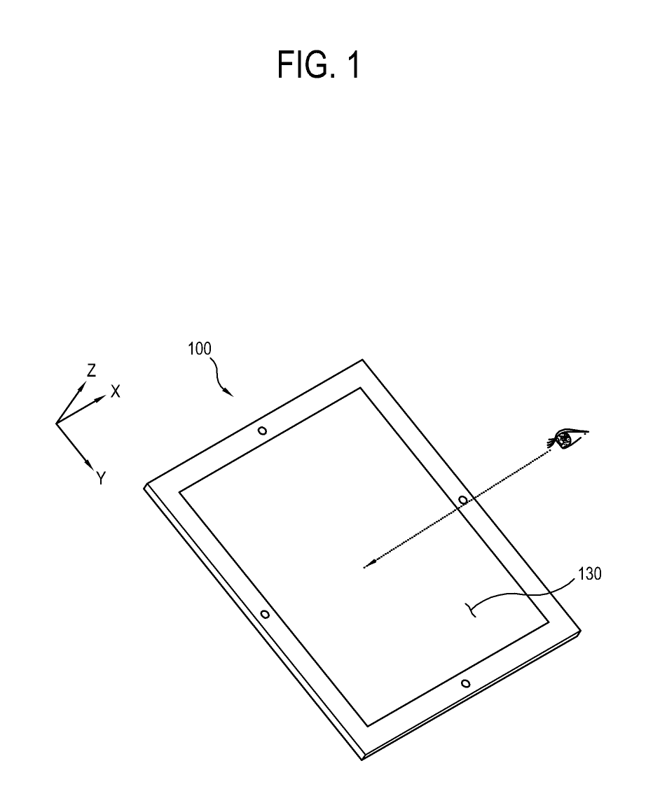

FIG. 1 illustrates a display apparatus 100 according to a first exemplary embodiment.

As shown in FIG. 1, the display apparatus 100 according to the present embodiment is configured as a tablet device with a rectangular plate shape. However, such an example is employed only for illustrative purposes. Therefore the display apparatus 100 is not limited to the foregoing example or form illustrated in the present embodiment. In other words, the display apparatus 100 may be provided as any device with various forms capable of displaying an image, for instance, a TV and monitor, without being limited to the tablet device.

Directions shown in FIG. 1 are defined as follows. X, Y, and Z directions of FIG. 1 indicate width, length, and height directions of the display apparatus 100, respectively. The apparatus 100 is disposed to be parallel with an X-Y plane defined by an X-axis and a Y-axis. A Z-axis is perpendicular to the X-Y plane, and may not be parallel with a gravity direction depending on a spatial arrangement of the display apparatus 100. Opposite X, Y, and Z directions are directions expressed as −X, −Y, and −Z, respectively.

The display apparatus 100 includes a display 130 displaying an image on one surface thereof such that a user may perceive the image displayed on the display 130.

The display apparatus 130 according to the present embodiment adopts a flexible display panel, which is bent at a predetermined curvature by an external force applied by the user.

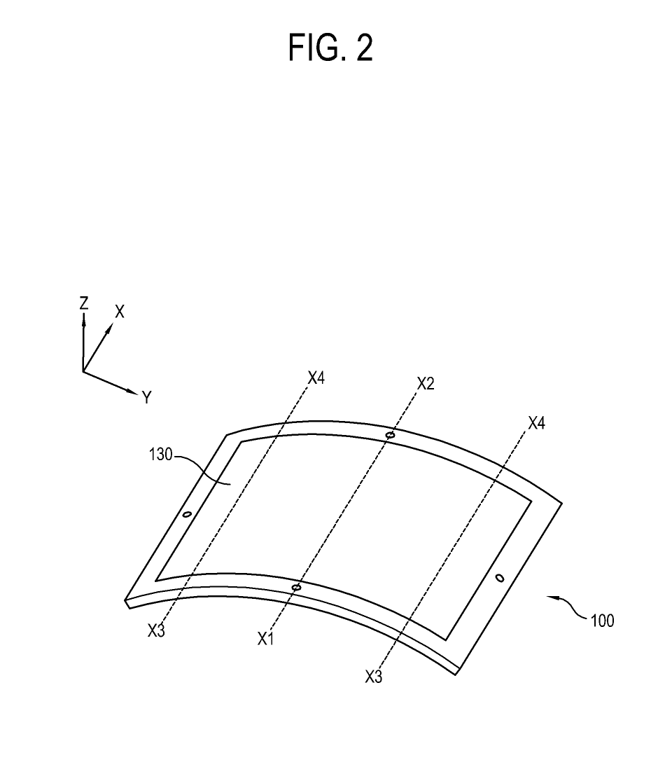

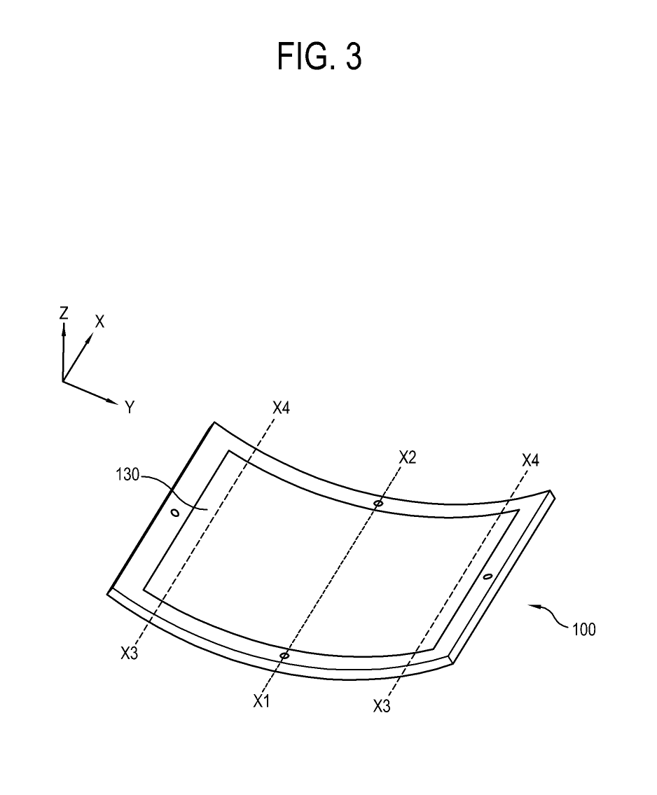

FIG. 2 illustrates the display apparatus 100 which is bent convexly, and FIG. 3 illustrates the display apparatus 100 which is bent concavely.

As shown in FIG. 2, the display apparatus 100 may be bent by an external force along the X-axis or Y-axis. To allow the display apparatus 100 to be bent, a flexible structure is applied not only to the display 130 but also to other components of the display apparatus 100 (such as a housing, which is not shown).

For example, the user may hold upper and lower sides of the display apparatus 100 in a lengthwise direction of the display apparatus 100 and apply an external force to the display apparatus 100 such that a central area of the display apparatus 100 curves upwards. The central area of the display apparatus 100 is bent convexly by the external force. Therefore, each area of the display apparatus 100 may have a different curvature value. A curvature on a line X1-X2 may be defined by crossing the central area as a maximum value. Thus, curvatures in other areas, for example, on lines X3-X4 crossing upper and lower edge areas of the display apparatus 100 have lower values than the curvature on the line X1-X2. That is, as seen from FIG. 2, the central area of the display apparatus 100 is bent to a relatively greater degree, while the upper and lower edge areas of the display apparatus 100 are bent to a relatively lesser degree.

As shown in FIG. 3, the display apparatus 100 may be bent by an external force such that the central area curves downwards, that is, the central area is bent concavely (as viewed from the top). In this case, an absolute value of a curvature on a line X1-X2 has a maximum value. An absolute value of a curvature on a line X3-X4 has a lower value than the line X1-X2. A bending direction of FIG. 2 is opposite to a bending direction of FIG. 3. Thus, a curvature in FIG. 2 is defined as (+), and a curvature in FIG. 3 is defined as (−).

As such, various methods may be employed to represent a bending state of a specified area using a curvature. For instance, when a curvature of an area which is flat and not bent is defined as 0, a curvature may be expressed as 2, 3, 4, etc. with the area being bent in the Z direction and as −2, −3, −4, etc. with the area being bent in the −Z direction. That is, in defining the curvature, (+) and (−) represent bending directions and a numerical value represents a degree to which the area is bent. This method, however, is provided for illustrative purposes only, and a curvature may be represented by various methods without particularly being limited.

An image displayed on the bent display 130 may be perceived as a distorted form by the user. For example, when a line of sight (hereinafter, “sightline”) of the user is directed to the line X1-X2, the line X3-X4 is apart from the sightline of the user and out of sight of the user. If an image is displayed on the display 130 which is flat, the sightline of the user allows the user to easily perceive the entire surface of the display 130. However, when the display 130 is bent as in FIG. 2 or 3, a region of the entire surface of the display 130 may be out of the sight of the user or not perceived by the user (depending on where the sightline of the user is directed).

The display apparatus 100 according to the present embodiment enables the user to perceive an image with minimal distortion. Therefore, the present embodiment enables the user to perceive an image with minimal distortion even when the display 130 is bent.

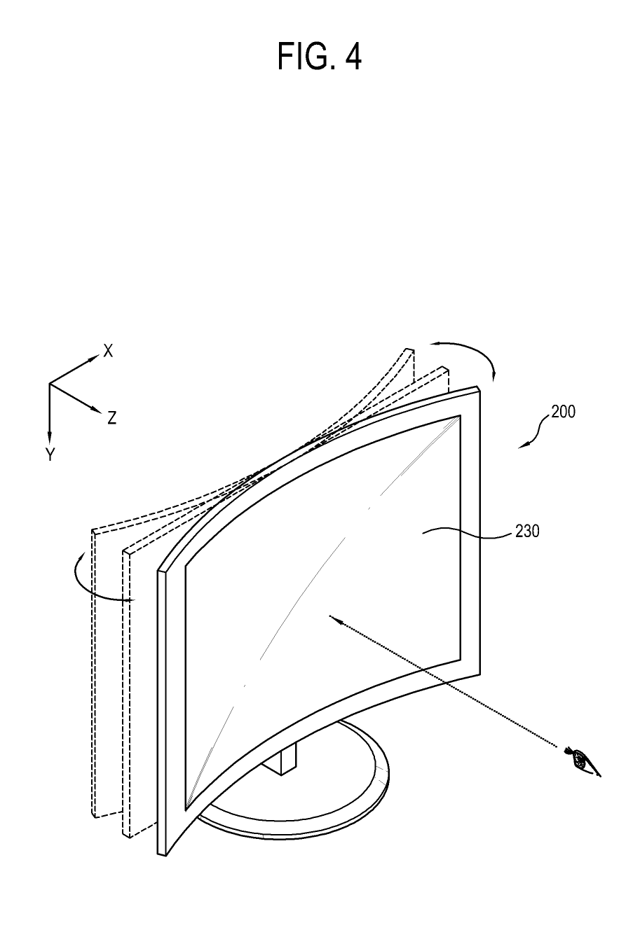

FIG. 4 illustrates a display apparatus 200 according to a second exemplary embodiment.

As shown in FIG. 4, the display apparatus 200 may be configured as a standing TV or a tablet device. The display apparatus 200 according to the present embodiment may have a structure of bending a display 230 by an external force by the user in the same manner as in the first embodiment. Alternatively, the display apparatus 200 may have a separate frame and motor structure (not shown) installed for bending the display 230, thereby bending the display 230 by the user controlling the motor structure (not shown) through an input unit (not shown) such as a remote controller of the display apparatus 200.

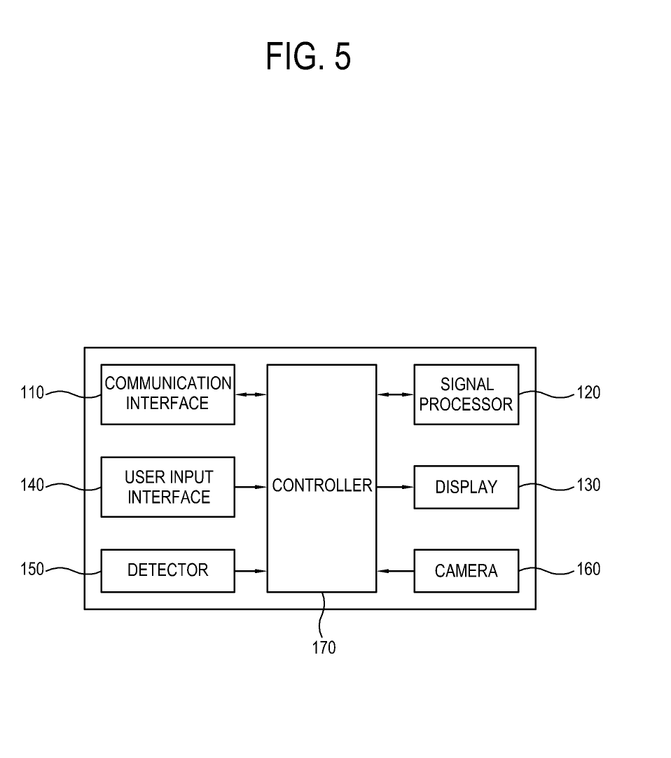

Hereinafter, a configuration of the display apparatus 100 according to the first embodiment will be described with reference to FIG. 5.

FIG. 5 is a block diagram illustrating the configuration of the display apparatus 100.

As shown in FIG. 5, the display apparatus 100 includes a communication interface 110 to externally communicate outside of the display apparatus 100 by transmitting and receiving data and signals, a signal processor 120 to process a signal received by the communication interface 110 according to a preset process, the display 130 to display an image based on a signal processed by the signal processor 120 if the processed signal is related to an image, a user input interface 140 to perform an input operation by the user, a detector 150 to detect whether the display 130 is bent, a camera 160 to photograph an external environment of the display apparatus 100, and a controller 170 to control overall operations of the display apparatus 100.

The communication interface 110 conducts data transmission and reception to enable the display apparatus 100 to perform two-way communications with an external device (not shown). The communication interface 110 connects to the external device in a wired-based, wireless wide area network (WAN), local area network (LAN), or a local access method according to a preset communication protocol.

As the communication interface 110 may be configured as an assembly of connection ports or connection modules for separate devices, a protocol for connection or an external device (not shown) as a connection target is not limited to a single kind or format. The communication interface 110 may be embedded in the display apparatus 100, or entire configuration of the communication interface 110 or part of the configuration may be additionally installed in the display apparatus 100 as an add-on.

Since signal transmission and reception may be achieved according to a protocol specified for each connected device, the communication interface 110 may transmit and receive a signal based on an individual connection protocol for each connected device. For example, in the case of image data, the communication interface 110 may transmit and receive a radio frequency (RF) signal and various signals in accordance with composite video, component video, super video, SCART, high definition multimedia interface (HDMI), DisplayPort, unified display interface (UDI) or wireless HD standards.

The signal processor 120 performs various processes on data received by the communication interface 110. When the communication interface 110 receives image data, the signal processor 120 performs an image processing process on the image data and outputs the processed image data to the display 130 to display an image based on the image data on the display 130. When the communication interface 110 receives a broadcast signal, the signal processor 120 extracts an image, an audio and additional data from the broadcast signal tuned to a particular channel, and adjusts the image to a preset resolution to be displayed on the display 130.

The signal processor 120 may perform any kind of image processing, without being limited to, for example, decoding corresponding to an image format of image data, de-interlacing to convert interlaced image data into a progressive form, scaling to adjust image data to a preset resolution, noise reduction to improve image quality, detail enhancement, frame refresh rate conversion, or the like.

The signal processor 120 may perform various processes based on data types and characteristics, without being limited to an image processing processes. Further, data to be processed by the signal processor 120 is not necessarily received by the communication interface 110. For instance, when a user utterance is input through the user input interface 140, the signal processor 120 processes data of the utterance according to a preset audio processing process. When a user gesture is detected by the camera 160, the processor may process a detection result according to a preset gesture processing process.

The signal processor 120 may be configured as an image processing board (not shown) formed by mounting an integrated multi-functional component, such as a system on chip (SOC), or separate components which independently conduct individual processes on a printed circuit board and be embedded in the display apparatus 100.

The display 130 displays an image based on image data processed by the signal processor 120. Although a display mode of the display 130 is not particularly limited, the display 130 employs a flexible display panel bendable by an external force. Since the display 130 is necessarily bendable, a self-luminous panel is adopted instead of a non-self-luminous panel which needs a backlight unit such as an LCD.

The user input interface 140 transmits various preset control commands or information to the controller 170 based on a user manipulations or inputs. The user input interface 160 arranges various events happening by a user based on a user intent into information and transmits the information to the controller 170. Here, various forms of events happen by a user, for example, key/button manipulations, an utterance, and a gesture.

The detector 150 detects bending of the display 130 on a horizontal axis or vertical axis and transmits a detection result to the controller 170. The controller 170 may deduce and determine, based on the detection result detected by the detector 150, which axis the display 130 is bent and what a curvature of each area of the display 130 is. Therefore, the detector 150 may be configured variously, without being particularly limited. For example, the detector 150 may be provided as a bar-shaped sensor extending along at least one of the horizontal axis and the vertical axis of the display 130, which is configured to calculate stress applied to one area of the sensor by bending as a numerical value, and output the value.

The camera 160 photographs an external environment of the display apparatus 100. In particular, the camera 160 takes an image of the user, and transmits a photographed result to the controller 170. The camera 160 according to the present embodiment employs an eye-tracking structure for tracking movements of the user's eyes to detect a direction of the sightline of the user. That is, the camera 160 detects the sightline of the user so that the controller 170 determines which area of the display 130 the sightline of the user is directed. Various eye-tracking structures and methods may be implemented according to exemplary embodiments. Thus, descriptions thereof are omitted herein.

The controller 170 is configured as a central processing unit (CPU) and controls operations of all components of the display apparatus 100 (including the signal processor 120) as an event happens. For example, when the communication interface 110 receives image data of content, the controller 170 controls the signal processor 120 to process the image data to be displayed as an image on the display 130. Further, when a user input event happens through the user input interface 140, the controller 170 controls components which include the signal processor 120 to perform a preset operation corresponding to the event.

Hereinafter, a configuration of the signal processor 120 according to the present embodiment will be described in detail.

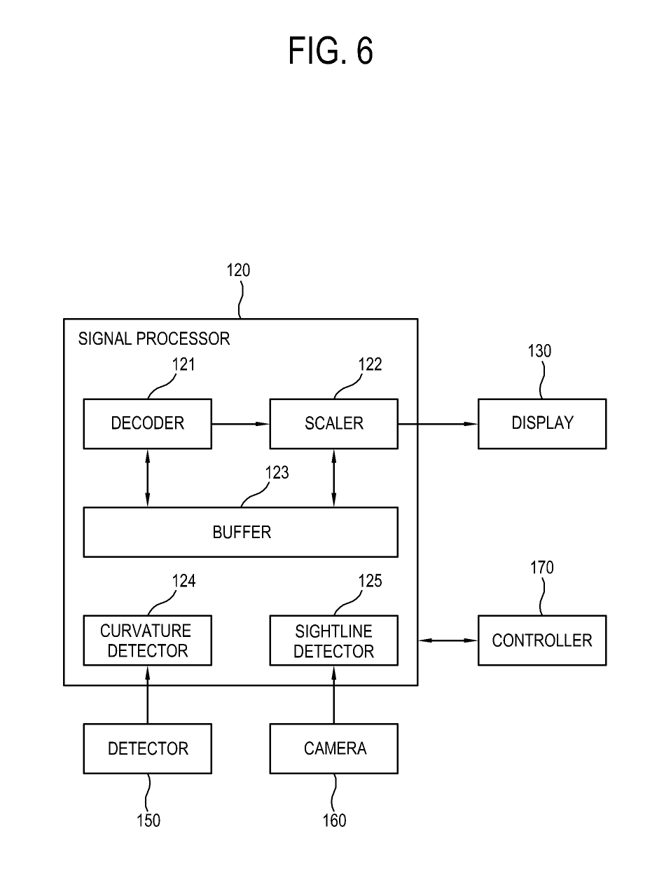

FIG. 6 is a block diagram illustrating the configuration of the signal processor 120. FIG. 6 illustrates components directly related to the present embodiment only, and the signal processor 120 may include components other than that described below.

As shown in FIG. 6, the signal processor 120 includes a decoder 121 to decode image data into a preset format, a scaler 122 to scale image data, a buffer 123 to temporarily store image data to be processed by the signal processor 120, a curvature detector 124 to determine a curvature of the display 130 in each area based on a bending detection result of the display 130 detected by the detector 150, and a sightline detector 125 to determine an area of the display 130 in which the sightline of the user is directed to based on a photographed/detection result by the camera 150.

The decoder 121 decodes and transmits received image data to the scaler 122 if the image data is encoded. If the image data is uncoded and uncompressed and does not need decoding, the decoder 121 may transmit the image data to the scaler 122 without decoding or the image data may be transmitted to the scaler 122, bypassing the decoder 121.

The scaler 122 scales image data to a resolution of the display 130 and outputs the image data to the display 130 so that the image data is displayed on the display 130, if a resolution of the image data is different from the resolution of the display 130.

Scaling includes upscaling and downscaling. For instance, an original resolution of image data is defined as a first resolution and a resolution of a display region for displaying the image data as a second resolution. Upscaling is a process of scaling the image data to the second resolution when the first resolution is lower than the second resolution, and downscaling is a process of scaling the image data to the second resolution when the first resolution is higher than the second resolution. For example, when image data has a horizontal resolution of 1080 pixels, upscaling is a process of scaling the image data to a display region with a horizontal resolution of 1280 pixels, while downscaling is a process of scaling the image data to a display region with a horizontal resolution of 860 pixels.

The curvature detector 124 determines a curvature of each area of the display 130 or each pixel line of the display 130 when the display 130 is bent. The curvature detector 124 determines a curvature based on a detection result by the detector 150.

For example, when the display 130 is bent on the Y-axis as shown in FIGS. 2 and 3, the curvature detector 124 determines curvatures on pixel lines X1-X2 and X3-X4 which are parallel with the X-axis of the display 130. In FIGS. 2 and 3, the pixel line X1-X2 has a maximum curvature among a plurality of pixel lines parallel with the X-axis of the display 130. When the display 130 is bent on the X-axis unlike in FIGS. 2 and 3, the curvature detector 124 may determine curvatures of pixel lines parallel with the Y-axis of the display 130.

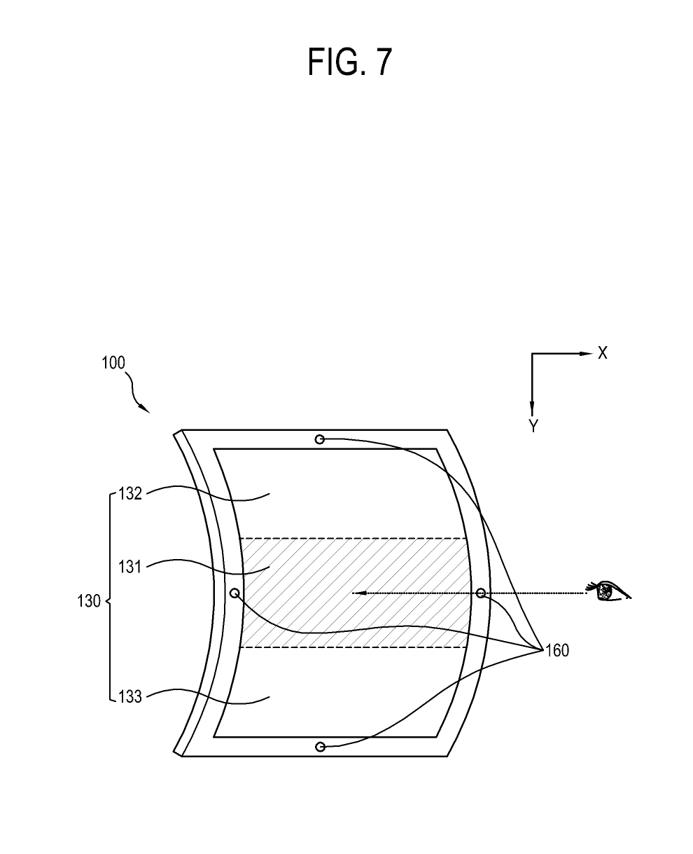

FIGS. 7 to 9 illustrate an overall view of the bent display 130.

FIG. 7 shows that the central area of the display apparatus 100 is bent convexly towards the user and the sightline of the user is directed to the central area.

When perceiving an image displayed across the display 130, the user is able to easily perceive an image in a first area 131 including the central area. However, a second area 132 on an upper edge of the display 130 and a third area 133 on a lower edge of the display 130 which are out of the first area 131 are out of the sight of the user or are distant from the eyes of the user as compared with the first area 131. Thus, the user perceives an image in the second area 132 or the third area 133 to be relatively distorted or has difficulty in perceiving the image. If the image includes a text, the user easily reads the text displayed in the first area 131 but may not read the text in the second area 132 or the third area 133.

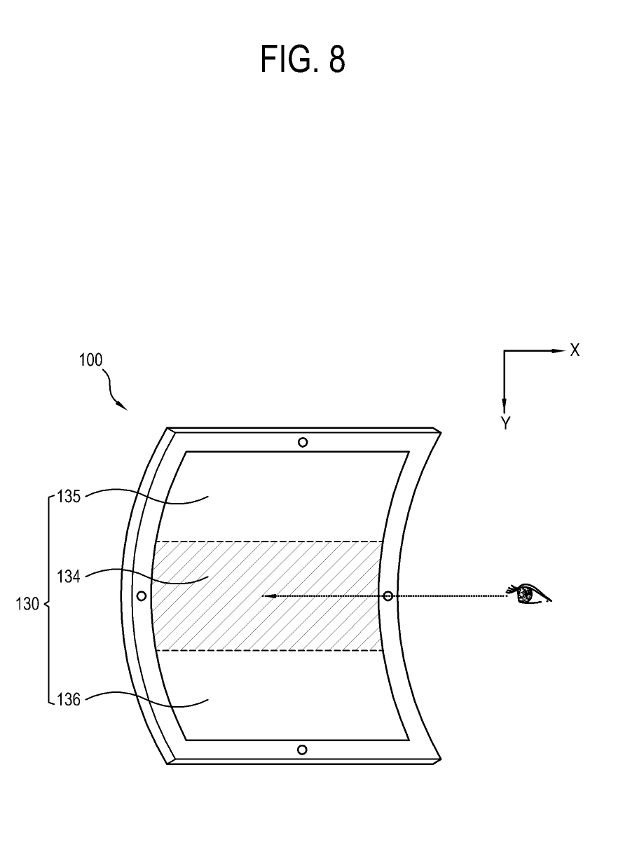

FIG. 8 shows that the central area of the display apparatus 100 is bent concavely from the user and the sightline of the user is directed to the central area.

In this case, a first area 134 including the central area of the display 130 is more distant from the eyes of the user than the first area 131 in FIG. 7. However, the first area 134 may be more easily perceived by the user than a second area 135 on the upper edge of the display 130 and a third area 136 on the lower edge which is out of the sightline of the user.

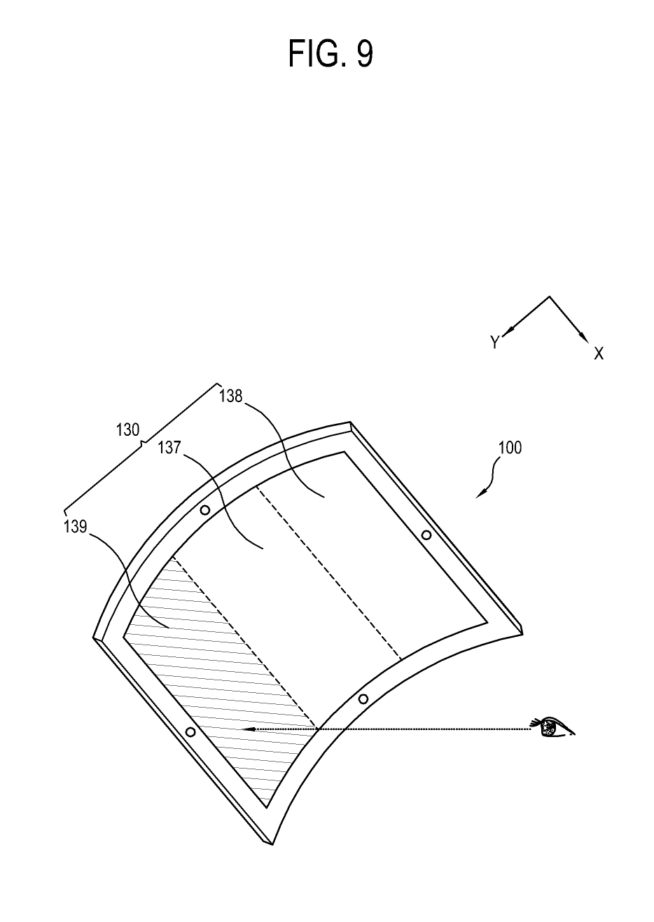

FIG. 9 shows that the central area of the display apparatus 100 is concavely bent and the sightline of the user is directed to a third area 139 on the lower edge of the display 130 instead of a first area 137 including the central area of the display 130 or a second area 138 on the upper edge of the display 130.

In this case, as the first area 137 and the second area 138 are out of the sightline of the user, the user may easily perceive the third area 139.

As illustrated in FIGS. 7 to 9, when the display 130 is bent, the user has difficulty in perceiving an area out of the sightline of the user (even if the sightline of the user is directed in any direction). Thus, the display apparatus 100 adjusts a mode of displaying an image in an area to which the sightline of the user is directed when the display 130 is bent. Thus, the user easily perceives the image based on the present embodiment.

Accordingly, in the present embodiment, the display apparatus 100 determines through the detector 150 whether the display 130 is bent while an image is displayed on the display 130, and if the display 130 is bent, divides through the camera 160 an entire display area of the display 130 into a target area which the sightline of the user is directed to and a remaining area which the sightline of the user is not directed to. The display apparatus 100 adjusts a displayed state of the image in at least one of the target area and the remaining area of the display 130.

Hereinafter, a target area refers to an area of the entire image display area of the display 130 which the sightline of the user is directed to, while a remaining area refers to an area other than the target area, which is out of a sightline range of the user.

Various methods may be available to adjust the displayed state of the image, for example, a method of adjusting a scale of the image and a method of adjusting a brightness of the image.

A method of adjusting a scale of an image includes a method of downscaling or upscaling the image. For example, the display apparatus 100 downscales and displays an image corresponding to the entire image display area of the display 130 to a resolution of the target area. The display apparatus 100 displays the entire image in the target area. Accordingly, the user may perceive the entire image minimally distorted.

As such, when downscaling the entire image to be displayed in the target area, the display apparatus 100 may not display the image in the remaining area out of the sightline range of the user. If the display 130 is a self-luminous panel, the display apparatus 100 may block power supply to the remaining area, thereby displaying no image in the remaining area.

Alternatively, the display apparatus 100 upscales and displays an image corresponding to the target area, with respect to the entire image displayed across the image display area of the display 130. Upscaling the image in the target area brings an effect of enlarging the image. Accordingly, the user may feel as if the user sees the image in the target area through a magnifying glass.

In this case, the display apparatus 100 may maintain a scale of an image in the remaining area or not display the image in the remaining area.

A method of adjusting a brightness of an image may include a method of adjusting a brightness of the target area relatively higher than that of the remaining area. To this end, the display apparatus 100 may increase the brightness of the target area only, decrease the brightness of the remaining area with the brightness of the target area being maintained, or increase the brightness of the target area simultaneously with decreasing the brightness of the remaining area.

As described above, various methods may be available to adjust the displayed state of the image in the target area.

When the external force to the display 130 is removed so that the display 130 returns to the original flat state from the bent state, the display apparatus 100 restores the displayed state of the image to an original state. In other words, when the display 130 returns to the flat state, the display apparatus 100 normally displays the image across the image display area of the display 130.

A range of the target area may be set by various methods based on a sight direction of the user detected by the camera 160.

For example, when a pixel area or pixel line to which the sightline of the user is directed is specified in the entire image display area of the display 130, the display apparatus 100 may determine an area with a preset pixel area range based on the specified pixel area or pixel line as a target area.

Alternatively, when a pixel area or pixel line to which the sightline of the user is directed is specified, the display apparatus 100 may obtain a curvature in the pixel area or pixel line and determine all pixel areas or pixel lines within a preset range of the curvature based on the pixel area or pixel line as a target area.

Alternatively, the display apparatus 100 may derive location information on two points of an eye tracking start point and an eye tracking end point in the entire image display area of the display 130 using the camera 160, and determine a rectangular area having the derived points as apexes as a target area.

The foregoing methods are provided for illustrative purposes only, and various methods may be employed depending on designs.

Hereinafter, an arrangement of the camera 160 for detecting the sightline of the user will be described.

When the display apparatus 100 has a rectangular plate shape as in the present embodiment, the display apparatus 100 may be bent in two bending patterns, that is, on the vertical axis and on the horizontal axis. According to the two bending patterns, four cameras 160 are installed in central areas of up, down, right and left edges of the display apparatus 100 (see FIG. 7).

If the display apparatus 100 has either of the two bending patterns, only two cameras 160 are installed on either of a pair of up and down edges or a pair of right and left edges depending on a bending pattern. If the display apparatus 100 is bent on the vertical axis, the cameras 160 are installed on the upper and lower edges. If the display apparatus 100 is bent on the horizontal axis, the cameras 160 are installed on the right and left edges.

The cameras 160 are disposed in the foregoing ways because the display 130 is bent. If the display 130 maintains a flat surface, the sightline of the user may be detected with a single camera 160 only. However, if only one camera 160 is installed on the display 130 that is bendable at random in the present embodiment, the camera 160 may not detect the sightline of the user depending on a bent state of the display 130.

The display apparatus 200 (see FIG. 4) according to the second embodiment, which is configured as a TV, has a relatively large size, and the user is generally positioned in front of the display apparatus 200. Thus, the camera 160 may detect the sightline of the user more easily in the second embodiment than in the first embodiment. Thus, only a single camera 160 may be installed in the second embodiment.

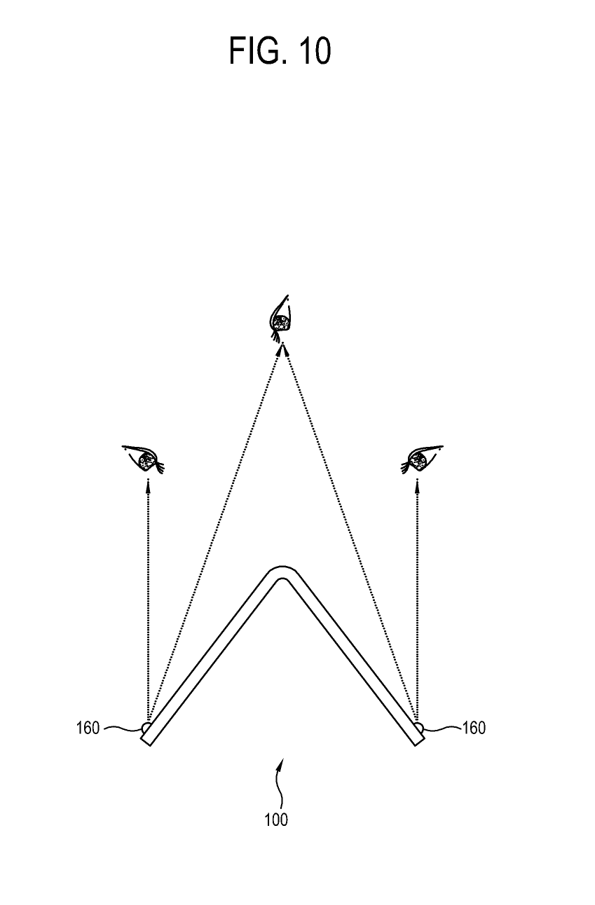

FIG. 10 illustrates that the camera 160 detects the sightline of the user when the display apparatus 100 is bent. In the following description with reference to FIG. 10, expressions “left” and “right” are based on directions shown in FIG. 10.

Referring to FIG. 10, when the display apparatus 100 is bent, cameras 160 are disposed on opposite edges of the bent display apparatus 100. The cameras 160 may detect the sightline of the user within a range of substantially 180 degrees. Thus, when the two cameras 160 are disposed as illustrated in FIG. 10, at least one of the cameras 160 may detect the sightline of the user as the user changes in location.

If the eyes of the user are at a left side, a right camera 160 of the two cameras 160 is unable to detect the sightline of the user. However, a left camera 160 is able to detect the sightline of the user. If the eyes of the user are at a right side, the left camera 160 is unable to detect the sightline of the user. However, the right camera 160 is able to detect the sightline of the user. If the eyes of the user are at the center, both cameras 160 are able to detect the sightline of the user.

The display apparatus 100 may detect the sightline of the user using such an arrangement of the cameras 160. However, an arrangement of the cameras 160 is not limited to the present embodiment, and various methods may be used to detect the sightline of the user.

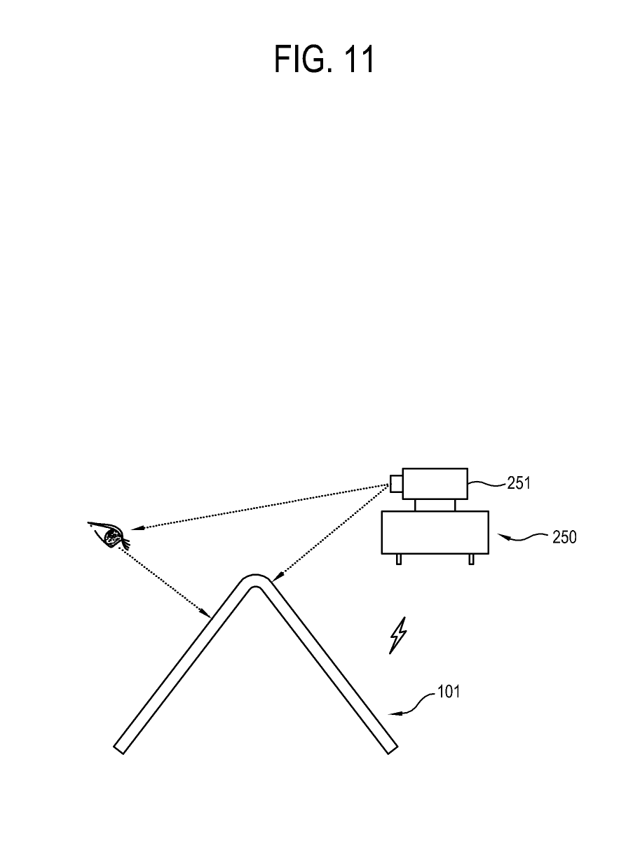

FIG. 11 illustrates a method of detecting a sightline of a user using a camera 251 according to a third exemplary embodiment.

As shown in FIG. 11, a display apparatus 101 communicates with an external device 250 including the camera 251. The camera 251 photographs the sightline of the user and a shape of the display apparatus 101, and the external device 250 determines based on a photographed result whether the display apparatus 101 is bent and which area of the display apparatus 101 the sightline of the user is directed.

The external device 250 transmits a determination result to the display apparatus 101, and the display apparatus 101 may specify where the sightline of the user is directed to based on the determination result received from the external device 250.

Alternatively, the external device 250 transmits only a detection result by the camera 251 to the display apparatus 101, and the display apparatus 101 determines based on the detection result which area of the display apparatus 101 the sightline of the user is directed to.

This structure may provide an environment for detecting the sightline of the user even though the camera 251 is not installed in the display apparatus 101.

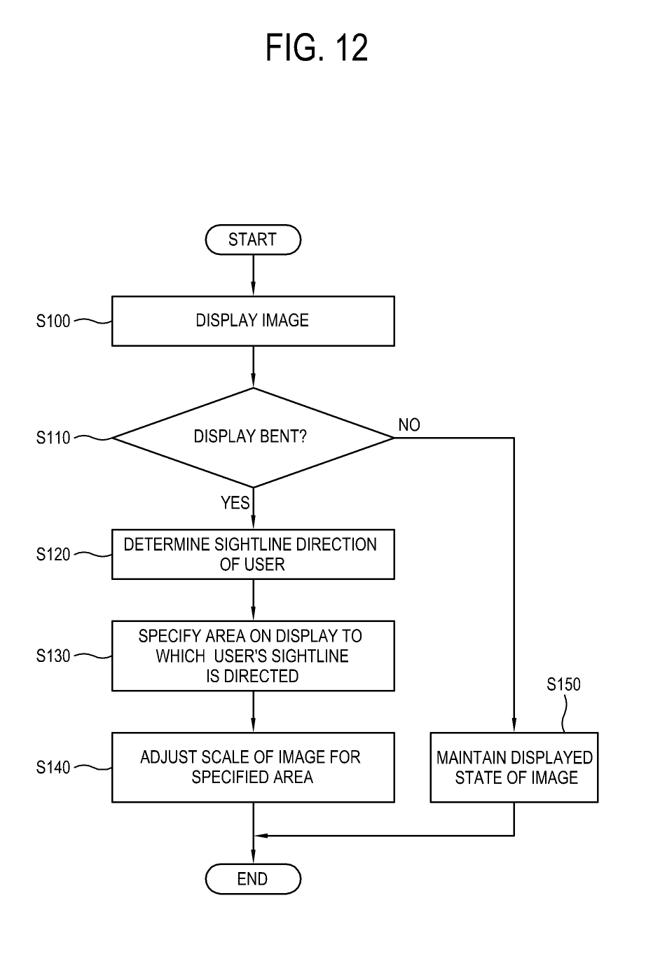

Hereinafter, a control method of a display apparatus 100 according to a fourth exemplary embodiment will be described with reference to FIG. 12. The display apparatus 100 according to the present embodiment has a structure substantially the same as that of the first embodiment. In the control method, an initial state of the display apparatus 100 is defined as a flat surface state.

FIG. 12 is a flowchart illustrating the control method of the display apparatus 100 according to the fourth embodiment.

As shown in FIG. 12, the display apparatus 100 processes image data to display an image in operation S100. The display apparatus 100 determines whether a display 130 is bent in operation S110.

When the display 130 is bent, the display apparatus 100 determines a sightline direction of the user in operation S120. The display apparatus 100 specifies an area on the display 130 to which a sightline of the user is directed to in operation S130. The display apparatus 100 adjusts a scale of the image for the specified area in operation S140.

Meanwhile, when the display 130 is determined not to be bent in operation S110, the display apparatus 100 maintains the image as it is in operation S150.

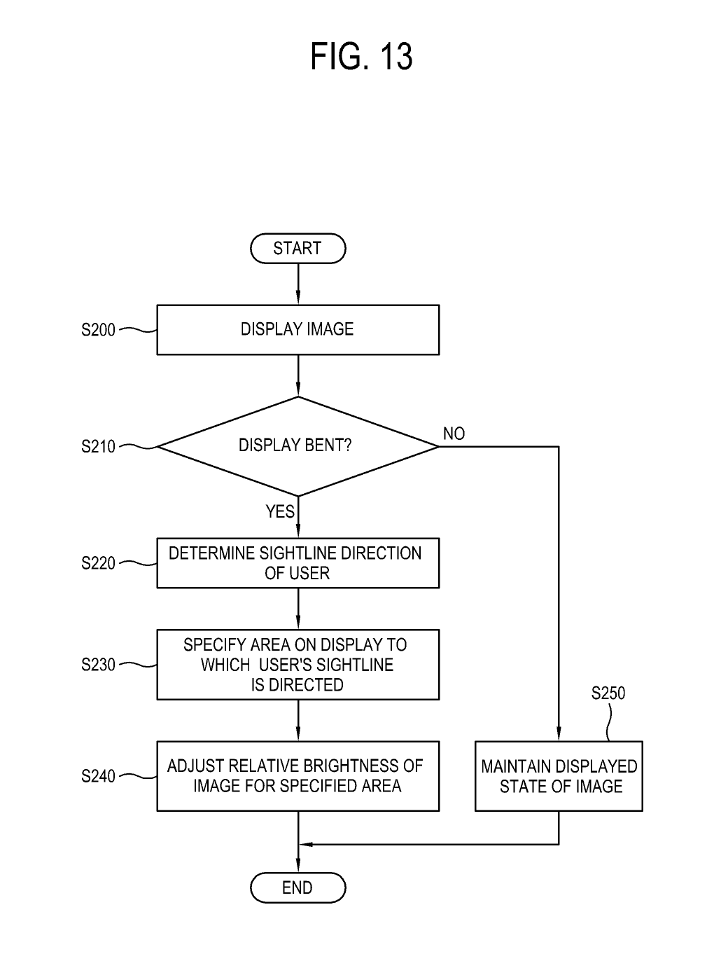

Hereinafter, a control method of a display apparatus 100 according to a fifth exemplary embodiment will be described with reference to FIG. 13. The display apparatus 100 according to the present embodiment has a structure substantially the same as that of the first embodiment. In the control method, an initial state of the display apparatus 100 is defined as a flat surface state.

FIG. 13 is a flowchart illustrating the control method of the display apparatus 100 according to the fifth embodiment.

As shown in FIG. 13, the display apparatus 100 processes image data to display an image in operation S200. The display apparatus 100 determines whether a display 130 is bent in operation S210.

When the display 130 is bent, the display apparatus 100 determines a sightline direction of the user in operation S220. The display apparatus 100 specifies an area on the display 130 to which a sightline of the user is directed to in operation S230. The display apparatus 100 adjusts a relative brightness of the image for the specified area in operation S240. That is, the display apparatus 100 adjusts a brightness of the image in the specified area to be higher than a brightness of the image in a remaining area.

Meanwhile, when the display 130 is determined not to be bent in operation S210, the display apparatus 100 maintains the image as it is in operation S250.

Various embodiments may be realized to adjust a displayed state of an image when a display is bent, which will be described in detail below.

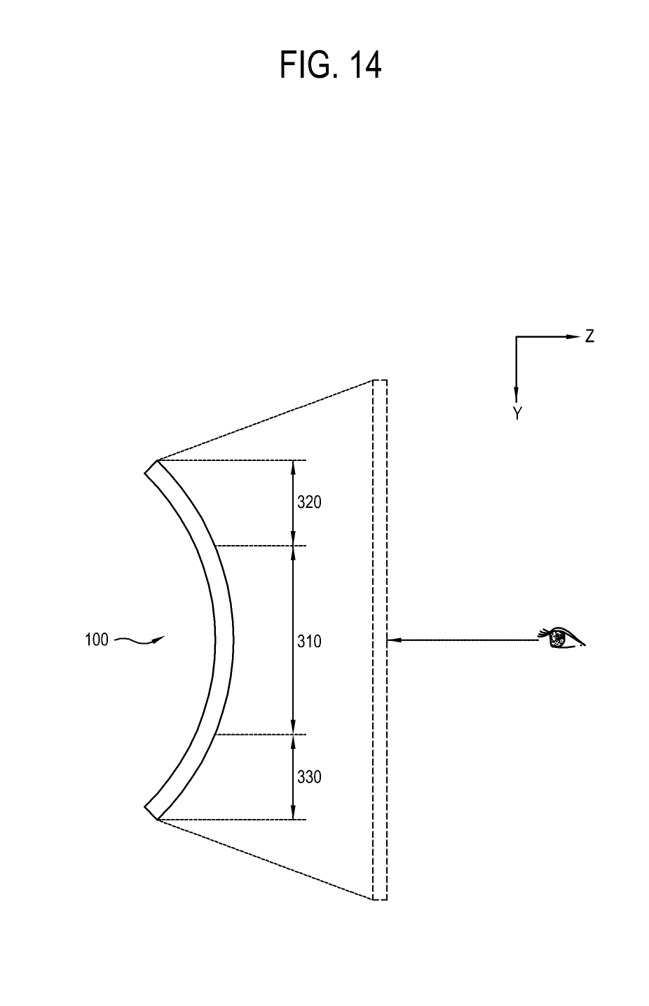

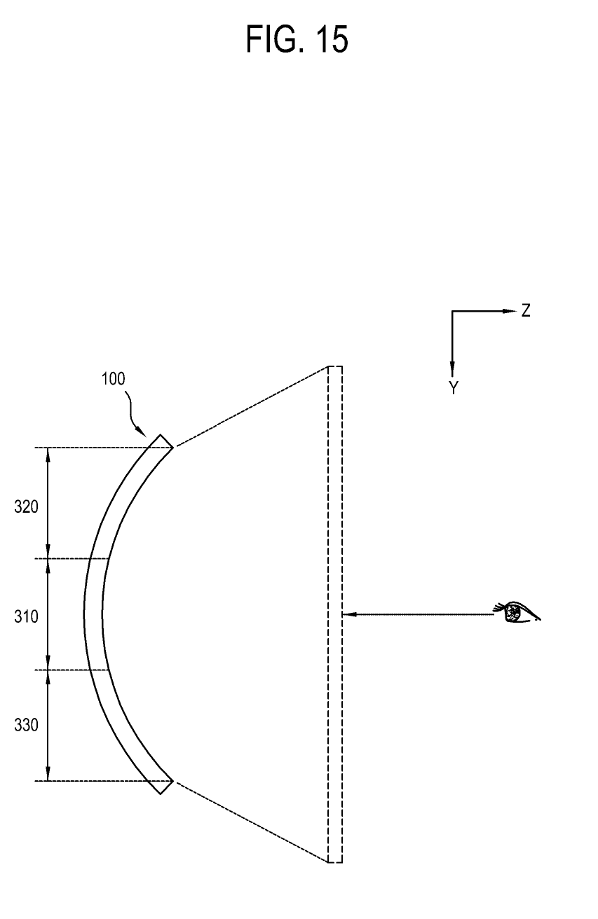

FIGS. 14 and 15 are lateral views illustrating a display apparatus 100 which is bent according to a sixth exemplary embodiment. The display apparatus 100 according to the present embodiment has a structure substantially the same as that of the first embodiment.

As shown in FIGS. 14 and 15, the display apparatus 100 is bent on the Y-axis and the user positioned in the Z direction is watching an image displayed on the display apparatus 100. A first area 310 of the display apparatus 100 as a central area is bent convexly to the user (see FIG. 13) or concavely from the user (see FIG. 14). The first area 310 is a target area to which a sightline of the user is directed and a second area 320 and a third area 330 above and below the first area 310 are a remaining area.

If the image displayed on the display apparatus 100 is subjected to no process, an extent of image distortion perceived by the user varies according to the areas 310, 320, and 330. The image in the first area 310 as the target area is normally perceived by the user, while the image in the second area 320 and the third area 330 as the remaining area is perceived by the user to a relatively great extent of distortion (e.g., the case in which the image perceived by the user does not look flat).

Accordingly, when a display 130 is bent, the display apparatus 100 detects the sightline of the user, divides the target area from the remaining area, and adjusts a scale of the image differently for the target area and the remaining area. Here, one of upscaling and downscaling may be used, wherein upscaling is performed for one of the target area and the remaining area if downscaling is performed for the other.

For example, when the target area 310 is close to the eyes of the user as compared with the remaining area 320 and 330 as shown in FIG. 14, the display apparatus 100 downscales the image in the target area 310 and upscales the image in the remaining area 320 and 330. As shown in FIG. 15, when the target area 310 is distant to the eyes of the user as compared with the remaining area 320 and 330, the display apparatus 100 upscales the image in the target area 310 and downscales the image in the remaining area 320 and 330. Accordingly, the user may ultimately perceive the image minimally distorted which looks almost flat.

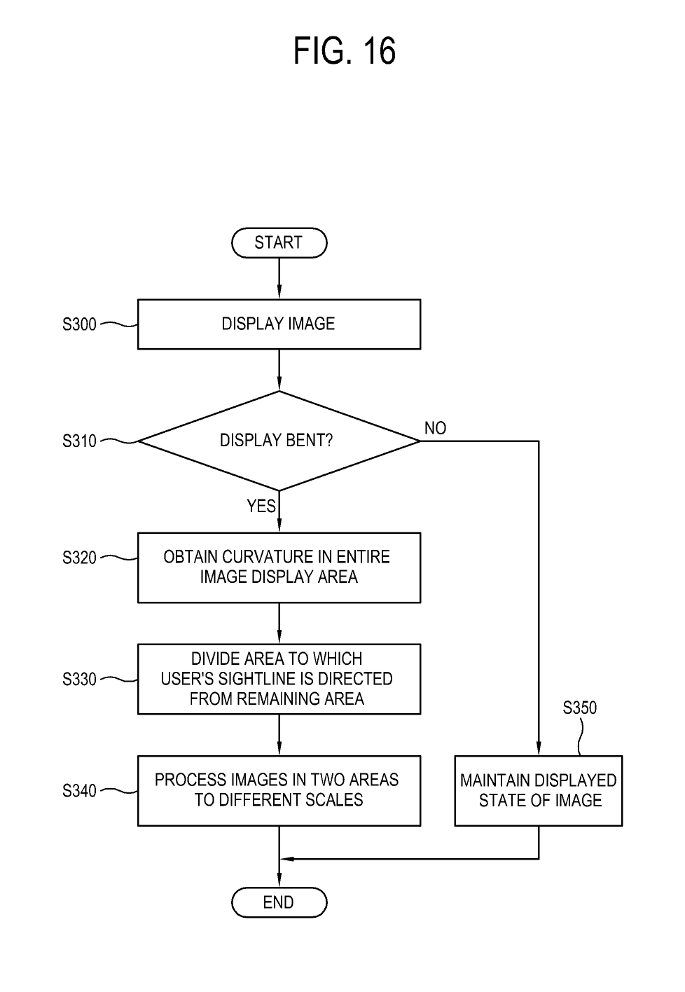

Hereinafter, a control method of the display apparatus 100 according to the present embodiment will be described with reference to FIG. 16.

FIG. 16 is a flowchart illustrating the control method of the display apparatus 100 according to the present embodiment.

As shown in FIG. 16, the display apparatus 100 processes image data to display an image in operation S300. The display apparatus 100 determines whether the display 130 is bent in operation S310.

When the display 130 is bent, the display apparatus 100 obtains a curvature with respect to an entire image display area in operation S320. The display apparatus 100 divides the entire image display area into an area to which the sightline of the user is directed and a remaining area based on the curvature in operation S330. That is, the display apparatus 100 determines, based on a pixel area detected as an area that the sightline of the user is directed to, all areas within a preset range of a curvature of the pixel area as the target area to which the sightline of the user is directed.

In operation S340, the display apparatus 100 adjusts the images in the two areas to different scales.

When the display 130 is determined not to be bent in operation S310, the display apparatus 100 maintains the image as it is in operation S350.

The foregoing embodiments show that the display apparatus or display is bent by an external force, and returns to the flat state when the external force is removed. However, the ideas of the preceding embodiments may be also applicable to a display apparatus or display that continuously maintains a bent state, which will be described below.

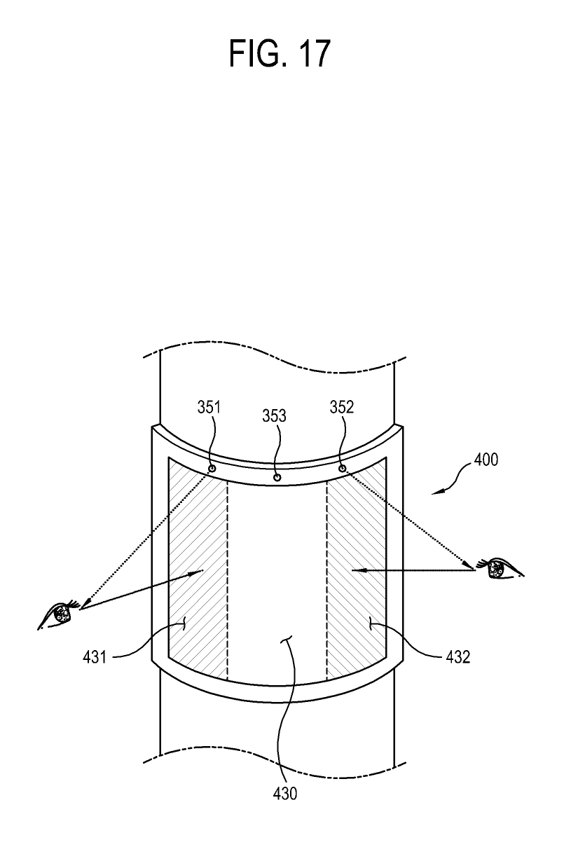

FIG. 17 illustrates a display apparatus 400 according to a seventh exemplary embodiment.

As shown in FIG. 17, the display apparatus 400 according to the present embodiment includes a display 430 and cameras 351, 352 and 353. Since the configurations of the display apparatuses illustrated in the aforementioned embodiments may be applicable to the display apparatus 400, a configuration of the display apparatus 400 is not described in detail.

The display apparatus 400 is installed on a stationary structure, such as a circular column. Thus, the display apparatus 400 maintains a bent state at a predetermined curvature.

One or more cameras 351, 352, and 353 are installed on the display apparatus 400. As the display apparatus 400 according to the present embodiment continuously maintains the bent state unlike those in the foregoing embodiments, the cameras 351, 352, and 353 are installed apart at proper positions based on where the user is expected to see the display apparatus 400. For example, when the user is at a left side on FIG. 17, a right camera 352 is unable to detect a sightline of the user, whereas a left camera 351 is able to detect the sightline of the user. When the user is at a right side on FIG. 17, the left camera 351 is unable to detect the sightline of the user, whereas the right camera 352 is able to detect the sightline of the user.

With this structure, the display apparatus 400 detects the sightline of the user using the cameras 351, 352, and 353 and specify areas 431 and 432 on a display 130 to which the sightline of the user is directed based on a detection result. The display apparatus 400 adjusts a scale of an image for the specified areas 431 and 432. That is, the display apparatus 400 adjusts a scale of an image corresponding to a left area 431 when the sightline of the user is directed to the left area 431. Also, the display apparatus 400 adjusts a scale of an image corresponding to a right area 432 when the sightline of the user is directed to the right area 432. Scaling an image has been described in detail in the foregoing embodiments. Thus, description thereof is omitted herein.

In the aforementioned exemplary embodiments, an image processing operation carried out when the display apparatus or display is bent may be set by the user. The display apparatus displays a user interface (UI) for setting an image processing operation, and the user may set the image processing operation to be performed or not to be performed using on/off settings on the UI.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a display configured to be bendable;
a signal processor configured to process an image signal to display an image on the display;
a detector configured to detect a bending state of the display;
a camera configured to detect a sightline of a user; and
a controller configured to control the signal processor to adjust a displayed state of the image for at least one of a first area and a second area in an entire display area of the display in response to the detected bending state of the display being detected by the detector,
wherein the first area corresponds to the detected sightline of the user detected by the camera, and
wherein the second area is a different area from the first area.

2. The display apparatus of claim 1, wherein the controller is further configured to adjust a scale of the image displayed in the at least one of the first area and the second area such that the displayed state of the image is adjusted.

3. The display apparatus of claim 2, wherein the controller is further configured to downscale and display an entire image in the first area at a resolution of the first area,
wherein the entire image corresponds to the entire display area.

4. The display apparatus of claim 3, wherein the controller is further configured to display no image in the second area when the downscaled image is displayed in the first area.

5. The display apparatus of claim 2, wherein the controller is further configured to upscale and display the image in the first area which corresponds to the first area of an entire image,
wherein the entire image corresponds to the entire display area.

6. The display apparatus of claim 2, wherein the controller is further configured to adjust a plurality of images to different scales which correspond to the first area and the second area, respectively.

7. The display apparatus of claim 1, wherein the controller is further configured to adjust a brightness of the image displayed in the at least one of the first area and the second area such that the displayed state of the image is adjusted.

8. The display apparatus of claim 7, wherein the controller is further configured to adjust the brightness of the first area to be a higher brightness than a brightness of the second area.

9. The display apparatus of claim 1, wherein the controller is further configured to restore the adjusted displayed state of the image to an original displayed state in response to the detector detecting that the display returns from a bent state to an original flat state.

10. The display apparatus of claim 1, wherein the controller is further configured to determine an area with a preset pixel area range based on a specified pixel area as the first area in response to a pixel area to which the sightline of the user is directed being specified in the entire display area by the detector.

11. The display apparatus of claim 1, wherein the controller is further configured to obtain a curvature of a specified pixel area and determine a pixel area within a preset range of the curvature from the specified pixel area as the first area in response to a pixel area to which the sightline of the user is directed being specified in the entire display area by the detector.

12. A control method of a display apparatus, the control method comprising:
detecting a bending state of a display of the display apparatus;
detecting a sightline of the user; and
adjusting a displayed state of an image for at least one of a first area and a second area in an entire display area of the display in response to the detected bending state of the display,
wherein the first area corresponds to the detected sightline of the user, and
wherein the second area is a different area from the first area.

13. The control method of claim 12, wherein the adjusting the displayed state of the image comprises adjusting a scale of the image displayed in the at least one of the first area and the second area.

14. The control method of claim 13, wherein the adjusting the scale of the image comprises downscaling and displaying an entire image in the first area at a resolution of the first area,
wherein the entire image corresponds to the entire display area.

15. The control method of claim 14, wherein the adjusting the scale of the image further comprises displaying no image in the second area when the downscaled image is displayed in the first area.

16. The control method of claim 13, wherein the adjusting the scale of the image comprises upscaling and displaying an image in the first area of an entire image,
wherein the entire image corresponds to the entire display area.

17. The control method of claim 13, wherein the adjusting the scale of the image comprises adjusting a plurality of images to different scales which corresponds to the first area and the second area, respectively.

18. The control method of claim 12, wherein the adjusting the displayed state of the image comprises adjusting a brightness of the image displayed in the at least one of the first area and the second area.

19. The control method of claim 18, wherein the adjusting the brightness of the image comprises adjusting the brightness of the first area to be a higher brightness than a brightness of the second area.

20. A control method of a display apparatus, the control method comprising:
displaying an image on an entire image display area of a display of the display apparatus;
detecting whether the display is bent;
detecting a sightline of a user;
obtaining a curvature with respect to the entire image display area of the display in response to detecting that the display is bent;
dividing the entire image display area into a first area in which the sightline of the user is detected and a second area which is a remaining area of the entire image display area based on the obtained curvature with respect to the entire image display area of the display; and
adjusting the image on the display to different scales depending on whether a portion of the image is in the first area or the second area.
